(19) United States
(12) Patent Application Publication
(10) Pub. No.: US 2022/0346410 A1
(43) Pub. Date: Nov. 3, 2022

(54) CHEMESTHETIC BEVERAGE

(71) Applicants: Elysia Cohn, San Mateo, CA (US); Tyler T. D'Spain, Denver, CO (US)

(72) Inventors: Elysia Cohn, San Mateo, CA (US); Tyler T. D'Spain, Denver, CO (US)

(21) Appl. No.: 17/244,637

(22) Filed: Apr. 29, 2021

(51) Int. Cl. A23L 2/56; A23L 2/68; A23L 2/60; A23L 2/44; A23L 2/58; A23L 2/38

(52) U.S. Cl. CPC A23L 2/56; A23L 2/68; A23L 2/60; A23L 2/44; A23L 2/58; A23L 2/38; A23V 2002/00

(57) ABSTRACT

Methods and compositions to produce non-alcoholic beverages that mimic the oral chemesthetic sensations of alcoholic spirits and liqueurs are disclosed. Compositions and combinations are disclosed to produce a beverage that delivers a heating sensation or “burn” similar to alcoholic spirits and liqueurs as well as provide the perception of viscosity, cooling, and aftertaste. Variations of flavoring components for producing different beverages are disclosed in different embodiments.

### BACKGROUND OF THE INVENTION

### Field of the Invention

The present general inventive concept is directed to a method of making a chemesthetic beverage and a composition for a non-alcoholic beverage that approximates the taste and sensation of an alcoholic beverage. The present general inventive concept is directed to a combination of ingredients suitable for human consumption with chemesthetic properties which mimic the sensations of drinking an alcoholic spirit or liqueur.

### Description of the Related Art

Attempts have been made to develop beverages that taste sweet with low calorie sweeteners. Other attempts have been made to adjust the taste, sweetness, or bitterness profile of a beverage by utilizing taste masking compounds. There are a number of elements of alcoholic beverages which have appealing characteristics. Some are carbonated, some provide a satisfying aroma, while others produce a warming sensation, viscosity or other desirable mouth feel. Water, as a base case, provides no aroma or flavor and can only provide heating or cooling based on its serving temperature. Numerous beverages populate the beverage industry that provide flavor or enjoyable characteristics. When compared to water, alcoholic beverages provide an experience suitable to sipping or enjoying the effect of imbibing a portion of the beverage. Alcoholic beverages can provide a more impactful experience as a sip of an alcoholic beverage can provide a complex range of flavors, aromas, and sensations. The complex “user interactions” of alcoholic beverages lead to a more engaging experience where “having a drink” can be an activity.

Alcoholic beverages have known consequences that can be negative including intoxication that can lead to loss of coordination, inability to operate a vehicle, or a hangover. Other attempts have been made to produce a non-alcoholic (NA) beverage that mimics alcoholic spirits or liqueurs, but existing formulations fall short of the desired product. The primary areas where current art in non-alcoholic beverages fall short include, but are not limited to, the sensation of an alcohol “burn,” the viscosity of a spirit when poured or consumed neat, and solubility, which limits the ability of the products to provide the strong flavor profiles that allow spirits and liqueurs to be mixed into cocktails. With the limitations of the related art, non-alcoholic spirits and liqueurs fail to offer a suitable replacement for their alcoholic counterparts.

What is needed is a non-alcoholic beverage that can provide the complex and engaging aspects of an alcoholic beverage without compromising the flavor, chemesthetic sensations, or tradition, of making a drink.

### SUMMARY OF THE INVENTION

It is an object of the present invention to provide a set of ingredients, which when combined in the appropriate ratios, can provide preferred chemesthetic properties of a spirit or liqueur without the presence of alcohol. The present invention provides a method and composition for achieving several user interactions characteristic of an alcoholic beverage or spirit. These user interactions include increased viscosity or mouth feel, a warming sensation, a cooling sensation, and a bitter sensation.

The above aspects of a non-alcoholic composition mimicking the chemesthetic sensations of alcoholic spirits can be obtained by a composition comprising approximately 0.01-0.1% of a plant-based gum, approximately 0.005-0.06% of capsicum extract, approximately 0.001-0.05% of bitterant, and approximately 0.001-0.003% menthol in a water based solution that can comprise additional colors, flavors, or preservatives. Herein, all percentages or weight percentages are provided in wt/wt format.

Another object of the current invention is to provide particular embodiments that mimic the taste and sensation profile of a particular alcoholic beverage. Embodiments within the scope of the invention include a gin replica, a liqueur replica, and an aperitif replica. Three representative non-alcoholic compositions are disclosed in detail that represent the diversity of the spirits and liqueurs which can be replicated using a combination of chemesthetic ingredients within the spirit of the invention. The above aspects can be obtained by combining different flavorings, sweeteners, preservatives, and emulsifiers in a water based solution, to mimic the flavors of common spirits, liqueurs, and aperitifs.

An embodiment of the present invention provides a non-alcoholic composition mimicking alcoholic gin comprising approximately 0.04-0.07% of xanthan gum, approximately 0.01-0.04% of capsicum extract, approximately 0.001-0.005% of bitterant, approximately 0.001-0.003% of menthol, approximately 0.1-0.2% of citric acid, approximately 0.005-0.1% of stevia, approximately 0.005-0.002% of vanillin, approximately 0.1-0.2% of emulsifier, approximately 0.03-0.06% of a preservative, approximately 1-2% of flavorings.

Another particular embodiment of the invention provides a non-alcoholic composition mimicking an alcoholic orange liqueur comprising approximately 0.05-0.08% of xanthan gum, approximately 0.01-0.04% of capsicum extract, approximately 0.001-0.005% of quinine, approximately 0.001-0.003% of menthol, approximately 0.1-0.2% of citric acid approximately 20-30% of erythritol, approximately 0.01-0.3% of monk fruit extract, approximately 0.002-0.005% of vanillin, approximately 0.1-0.2% of emulsifier, approximately 0.03-0.06% of preservative, and approximately 2-4% of flavorings in a water based solution.

Another particular embodiment of the invention provides a non-alcoholic composition mimicking a bittersweet aperitif comprising approximately 0.05-0.08% of xanthan gum, approximately 0.005-0.010% of capsicum extract, approximately 0.01-0.05% of quinine, approximately 0.001-0.003% of menthol, approximately 0.1-0.2% of citric acid, approximately 20-30% of erythritol, approximately 0.01-0.3% of monk fruit extract, approximately 0.002-0.005% of vanillin, approximately 0.1-0.2% of emulsifier, approximately 0.03-0.06% of preservative, approximately 1-3% of flavorings, approximately 0.1-0.5% of coloring, and approximately 0.1-0.5% of digestive root extracts in a water based solution.

A method of producing a non-alcoholic beverage to simulate an alcoholic beverage is disclosed wherein ingredients are added to an aqueous base comprising the steps of: providing a portion of water; adding 0.01-0.1 weight percent of a plant based gum; adding 0.005-0.06 weight percent of a capsicum extract; adding 0.001-0.05 weight percent of a bitterant; and adding 0.001-0.003 weight percent of a menthol.

These together with other aspects and advantages which will be subsequently apparent, reside in the detailed composition as more fully hereinafter described and claimed.

### DESCRIPTION OF THE PREFERRED EMBODIMENTS

Reference will now be made in detail to the presently preferred embodiments of the invention, examples of which are illustrated in detail, falling within the spirit of the invention.

The present inventive concept relates to a composition and method for preparing a chemesthetic beverage that approximates the experience of drinking an alcoholic beverage without the presence of alcohol.

Numerous efforts have been made to provide a non-alcoholic (NA) beverage that retains the favorable qualities of the beverage with ethanol. None of the known efforts have been successful in attaining the various aspects of “user interactions” of the original. It has been discovered that four of the more consistent user interactions present in alcoholic beverages can be approximated through the use of additives derived from natural sources. Each of these user interactions can be simulated with compounds that produce a sensory impression or reaction. Experimentation has produced a selection of additives and a range of concentrations that both provide the user interactions and provide a palatable and engaging alternative to alcoholic beverages. As described herein, percentage compositions are weight based and can be added to an aqueous or water based solution to provide a beverage.

One characteristic of beverages containing alcohol is the warming sensation or burn of high ethanol concentrations. The warming sensation is a distinct feeling that presents a favorable interaction. A first aspect of the inventive concept is to simulate a warming sensation. It has been found that the use of capsaicin derived from capsicum (hot chili pepper) extract provides a heating sensation similar to higher concentrations of ethanol in a beverage. It has been discovered through sensory experimentation that very low concentrations of capsaicin can be employed in a beverage to produce a warming sensation to the consumer. Capsaicin, the active component in hot chili peppers, stimulates a receptor which reports back on thermal changes, and this results in a heating sensation similar to a burning sensation provided by ethanol. Experimentation has revealed that 0.005% to 0.06% of capsicum extract can achieve a warming sensation, without producing an overly spicy sensation. One embodiment of the present invention provides 0.01% to 0.04% of capsicum extract to provide a warming sensation in a gin replica product in an embodiment of the invention. In another embodiment of the invention, an orange liqueur replica product can be produced with a similar amount of capsicum extract, 0.01% to 0.04% to produce a warming sensation. It has further been discovered that smaller amounts of capsaicin are desirable to replicate a beverage with lower alcohol content, such as an aperitif. An orange rhubarb aperitif replica beverage can be prepared to contain capsicum extract in a range of 0.005% to 0.01% to produce a beverage that presents a complex bitter and sweet flavor profile, which is well suited to mixing into non-alcoholic cocktails.

Another characteristic of alcoholic beverages is that they contain additional viscosity when compared to water. This makes the beverage seem to have more body, or to have a more substantial mouth feel and is one component of the user interactions experienced with conventional alcoholic beverages. Beverages without at least a slight increase to viscosity are perceived as ‘watery.’ A second aspect of the present inventive concept is to provide increased viscosity. It has been discovered that the perceived viscosity of conventional drinking spirits can be replicated with the addition of a plant-based gum, for example xanthan gum. Experimentation has revealed that 0.01% to 0.1% is sufficient to contribute a viscosity that mimics alcoholic beverages. It has been discovered through sensory analysis and observation that a concentration of 0.04% to 0.06% provides the desired viscosity while maintaining solution clarity. Concentrations above 0.06% were found to provide the desired viscosity and allow for higher concentrations of flavor compounds to be solubilized but contribute to a hazy appearance. In alternate embodiments of the invention, slightly more plant-based gum can be utilized, for example up to 0.08% to provide an orange liqueur or aperitif replica product, where the concentration of flavor compounds is high and the solution clarity is less important. Xanthan gum is an example of a plant-based gum derived from the fermentation of simple sugars that can simulate the viscosity that ethanol contributes. In an embodiment of the invention, the selected plant-based gum is xanthan gum. In other embodiments of the invention, the plant-based gum may be comprised of acacia gum, guar gum, locust bean gum, or similar gums, and the optimal concentration will vary depending on the gum.

Another characteristic of traditional alcoholic beverages is that a higher vapor pressure can provide a cooling sensation from the evaporation of more volatile components of the beverage, including ethanol. A third aspect of the present inventive concept is to provide a cooling sensation to the user. It has been found that a cooling sensation can be achieved in a NA beverage with the addition of menthol to a beverage solution. Menthol can chemically trigger a cold-sensitive receptor, resulting in a cooling sensation to elicit the feeling of evaporative cooling. The cooling sensation mimics the evaporative cooling sensation felt when drinking ethanol-based spirits. It has been discovered through experimentation that 0.001% to 0.003% can provide a suitable cooling effect. This range can be utilized for a variety of NA beverages in various embodiments of the invention and presents the desired cooling effect without unduly affecting the flavor of the beverage. Concentrations less than 0.001% menthol were found to provide less cooling than desired, while concentrations greater than 0.003% may be found to taste minty and feel overly cool, which reduces the similarity to the target beverage.

Traditional alcoholic beverages also present a slightly bitter aftertaste. The range of bitterness can vary greatly depending on the beverage type. A fourth aspect of the present inventive concept is to provide a bitter taste sensation. Experimentation has revealed that the addition of a bitterant in amounts of 0.001% to 0.003% on a weight basis is sufficient to mimic bitterness present in low bitterness spirits and liqueurs. The use of concentrations higher than 0.003% are typically perceived as overly bitter, unless the beverage is typically flavored with bitter ingredients. In an embodiment of the present invention, quinine has been found to be a suitable bitterant for a low bitterness replica product like an orange liqueur. Quinine has also been found to be a suitable bitterant for use in a bittersweet aperitif replica at a higher concentration ranging from 0.01% to 0.05% to produce the bitterness of an aperitif. Quinine is a bitter alkaloid that can function to mimic the slight bitter aftertaste similar to that experienced after drinking an alcoholic beverage. It has been discovered that quinine is effective when added in combination with the menthol, capsicum extract, and xanthan gum to provide an authentic mimic to an alcoholic beverage. A slightly bitter aftertaste, in addition to the other aspects of the user interactions experienced while drinking a beverage, provides the complex experience and interaction that makes a cocktail an engaging experience. In another embodiment of the present invention, the bitterant may be the same as the flavoring ingredients. In a gin replica product, the use of juniper berry extract is sufficient to provide the bitterness of a spirit, without the use of quinine. Juniper berry extract can serve as a bitterant, or can be utilized in addition to a bitterant, e.g. quinine, in an embodiment of the invention. Juniper berry extract can be utilized at concentrations of 0.1% to 2%, and more preferably at concentrations of 0.3% to 0.4% in an embodiment of the invention resembling gin.

In combination, these four aspects of the invention combine to create the complex flavor profile and mouth feel of conventional alcoholic beverages. The resulting beverages can provide sensations similar to drinking an alcoholic spirit or liqueur and can be combined with different flavor systems to mimic a wide variety of alcoholic beverages. It is a feature of the present invention to provide the important chemesthetic aspects of this system of ingredients which can be used to mimic alcoholic spirits or liqueurs without the presence of ethanol. When formulated with appropriate flavoring, the novel chemesthetic system yields non-alcoholic beverages with chemesthetic properties similar to alcoholic spirits or liqueurs. It is a particular aspect of the invention to provide an alcohol-like sensation in a composition comprising approximately 0.01-0.1% of plant-based gum; approximately 0.005-0.06% of capsicum extract; approximately 0.001-0.003% of menthol; and approximately 0.001-0.003% of bitterant for non-bitter replicas, with additional bitterant added as needed as a part of the flavoring up to 0.05% wherein the components are provided in an aqueous solution, in an embodiment of the invention. The combination of ingredients in the present inventive concept provides a similar chemesthetic sensation to drinking alcoholic spirits or liqueurs.

In a particular embodiment of the invention, the plant based gum can comprise xanthan gum. In another embodiment of the invention, the bitterant comprises 0.001-0.003% quinine. In said embodiment, the bitterant can comprise quinine as an extract of cinchona bark, the natural source of quinine, or quinine monohydrochloride dihydrate, the primary form of pure food grade quinine. Both forms are suitable to provide bitterness, although cinchona bark extract provides an earthy color and more flavor in addition to the desired bitter flavor. Due to different concentrations of quinine in cinchona bark extracts, the amount of extract used may be adjusted to result in a quinine concentration of 0.001-0.003%. In one preferred embodiment of the invention, quinine monohydrochloride dihydrate is the preferred bitterant due to its pure bitter flavor that doesn't impart additional color or excess flavor to the beverage.

Another embodiment of the invention wherein bitterant comprises 0.3-0.4% juniper berry extract which, when used as a flavoring for a gin replica beverage, provides bitterness similar to quinine. In said embodiment, the amount of juniper berry extract required to produce a gin like flavor was discovered to provide bitterness similar to that of 0.001-0.003% quinine. While said amount of juniper extract is appropriate for a gin replica beverage, the flavor of juniper is much too prominent to be used in other types of replica beverages.

Another embodiment of the invention provides a non-alcoholic composition mimicking alcoholic gin comprising approximately 0.04-0.07% of xanthan gum, approximately 0.01-0.04% of capsicum extract, approximately 0.3% to 0.4% juniper berry extract that can serve as a bitterant, approximately 0.001-0.003% of menthol, approximately 0.1-0.2% of citric acid (to provide acidity which improves flavor), approximately 0.005-0.1% of stevia (as a sweetener), approximately 0.0005-0.002% of vanillin (known to provide a natural mild sweetness), approximately 0.1-0.2% of emulsifier (for example lecithin, or polysorbate 20, 60, or 80 to prevent ingredient separation), approximately 0.03-0.06% of preservative (e.g. potassium sorbate or sodium benzoate, selected from a group of sorbic or benzoic acid derivatives), approximately 1-2% of flavorings (for example, water soluble extracts and essential oils of gin botanicals such as juniper, lemon, orange, or grapefruit at concentrations of 1-2%). Gin's flavor profile is highly complex and varies by manufacturer, though the flavor profile is most often predominantly of juniper and citrus. Suitable flavorings must be largely water soluble to provide a clear beverage. Common commercially available flavoring products are low in essential oil content and are typically provided in a solution of water and propylene glycol or glycerol. A small amount of essential oil (for example 0.01-0.05% of juniper essential oil) yields a more prominent aroma than the water soluble extracts. Concentrations greater than approximately 0.05% may yield an opaque beverage and may separate over time.

Another embodiment of the invention is to provide a non-alcoholic composition mimicking an alcoholic orange liqueur comprising approximately 0.05-0.08% of xanthan gum, approximately 0.01-0.04% of capsicum extract, approximately 0.001-0.005% of quinine monohydrochloride dihydrate, approximately 0.001-0.003% of menthol, approximately 0.1-0.2% of citric acid (to provide acidity which improves flavor), approximately 20-30% of erythritol (a low calorie sweetener), approximately 0.01-0.3% of monk fruit extract (which in addition to erythritol provides sweetness similar to sucrose), approximately 0.002-0.005% of vanillin (as a flavor enhancer), approximately 0.1-0.2% of emulsifier (e.g. lecithin, or polysorbate to prevent ingredient separation), approximately 0.03-0.06% of preservative (e.g. potassium sorbate or sodium benzoate, selected from a group of sorbic or benzoic acid derivatives), approximately 2-4% of flavorings (e.g. orange extract, orange flavor, orange oil, or blood orange oil based on the desired flavor intensity, where the flavorings comprised concentrations of 0.2-2% of water soluble extracts and concentrations of up to 0.1% oil soluble extracts, were found to be suitable).

Another embodiment of the invention provides a non-alcoholic composition mimicking a bittersweet aperitif comprising approximately 0.05-0.08% of xanthan gum, approximately 0.005-0.010% of capsicum extract, approximately 0.01-0.05% of quinine monohydrochloride dihydrate, approximately 0.001-0.003% of menthol. Additional ingredients in this particular embodiment provide the flavors, sweeteners, and other components necessary to replicate the flavor and character of an aperitif, including approximately 0.1-0.2% of citric acid (to provide acidity which improves flavor), approximately 20-30% of erythritol (as a low calorie sweetener), approximately 0.01-0.3% of monk fruit extract (used in combination with erythritol to provide sweetness similar to sucrose), approximately 0.002-0.005% of vanillin (as a flavor enhancer), approximately 0.1-0.2% of emulsifier (e.g. lecithin, or polysorbate to prevent ingredient separation), approximately 0.03-0.06% of preservative (e.g. potassium sorbate or sodium benzoate, selected from a group of sorbic or benzoic acid derivatives), approximately 1-3% of flavorings (for example, a combination of orange flavor, orange extract, orange oil, and grapefruit oil and rhubarb extract to provide a complex sweet citrus flavor and aroma, with an earthy and bitter rhubarb flavor, where concentrations of 0.2-3% of water soluble extracts and concentrations of up to 0.1% oil soluble extracts were found to be suitable), approximately 0.1-0.5% of coloring (e.g. red and yellow food coloring, to mimic the bold color typically found in a bittersweet aperitif), and approximately 0.1-0.5% of digestive root extracts (e.g. 0.1-0.3% chinchona bark extract to achieve desired bitterness, and 0.1-0.2% gentian extract to add a complex bitterness and increases the consumers appetite).

A method of producing a non-alcoholic beverage is disclosed wherein components are added to an aqueous base to provide a chemesthetic beverage that mimics the user interactions of an alcoholic beverage. In a container suitable for mixing, a portion of water or an aqueous base is provided. The method further comprises the steps of adding 0.01-0.1 weight percent of a plant based gum; adding 0.005-0.06 weight percent of a capsicum extract; adding 0.001-0.05 weight percent of a bitterant; and adding 0.001-0.003 weight percent of a menthol. This method provides four of the essential user interactions of an alcoholic beverage, namely mouth feel, a warming sensation, a cooling sensation, and a bitter taste sensation. Additional flavorings, colorings and preservatives can be added in other embodiments within the scope of the invention to provide particular replicas of specific alcoholic beverages. The ingredients disclosed above can be added in other embodiments of the method to produce a gin type beverage, a liqueur type beverage, an aperitif type beverage, or other NA replica beverages in the spirit of the invention.

The operations described herein can be performed in any sensible order. The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact composition and methods described, and accordingly all suitable modifications and equivalents may be resorted to, falling within the scope of the invention.

What is claimed is:

1. A non-alcoholic composition mimicking the chemesthetic sensations of alcoholic spirits comprising:
approximately 0.01-0.1% of plant based gum;
approximately 0.005-0.06% of capsicum extract;
approximately 0.001-0.05% of bitterant; and
approximately 0.001-0.003% of menthol.

2. The non-alcoholic composition of claim 1, wherein said plant based gum is 0.01-0.1% xanthan gum

3. The non-alcoholic composition of claim 1, wherein said bitterant is selected from the group of quinine monohydrochloride dihydrate, quinine sulfate dihydrate, or caffeine.

4. The non-alcoholic composition of claim 1, wherein said bitterant comprises 0.01-0.3% by weight quinine monohydrochloride dihydrate.

5. A non-alcoholic composition mimicking alcoholic gin comprising:
approximately 0.04-0.07% of xanthan gum;
approximately 0.01-0.04% of capsicum extract;
approximately 0.001-0.003% of menthol;
approximately 0.1-0.2% of citric acid;
approximately 0.005-0.1% of stevia;
approximately 0.005-0.002% of vanillin;
approximately 0.1-0.2% of emulsifier;
approximately 0.03-0.06% of preservative; and
approximately 1-2% of flavorings.

6. The non-alcoholic composition mimicking alcoholic gin of claim 5 wherein said approximately 1-2% of flavorings comprises 0.3-0.4% juniper berry extract.

7. A non-alcoholic composition mimicking an alcoholic orange liqueur comprising:
approximately 0.05-0.08% of xanthan gum;
approximately 0.01-0.04% of capsicum extract;
approximately 0.001-0.005% of quinine;
approximately 0.001-0.003% of menthol;
approximately 0.1-0.2% of citric acid;
approximately 20-30% of erythritol;
approximately 0.01-0.3% of monk fruit extract;
approximately 0.002-0.005% of vanillin;
approximately 0.1-0.2% of emulsifier;
approximately 0.03-0.06% of preservative; and
approximately 2-4% of flavorings.

8. A non-alcoholic composition mimicking a bittersweet aperitif comprising:
approximately 0.05-0.08% of xanthan gum;
approximately 0.005-0.010% of capsicum extract;
approximately 0.01-0.05% of quinine;
approximately 0.001-0.003% of menthol;
approximately 0.1-0.2% of citric acid;
approximately 20-30% of erythritol;
approximately 0.01-0.3% of monk fruit extract;
approximately 0.002-0.005% of vanillin;
approximately 0.1-0.2% of emulsifier;
approximately 0.03-0.06% of preservative;
approximately 1-3% of flavorings;
approximately 0.1-0.5% of coloring; and
approximately 0.1-0.5% of digestive root extracts.

9. A method for imparting multiple chemesthetic properties to a water based beverage to simulate an alcoholic beverage comprising the steps of:
providing a portion of water;
adding 0.01-0.1 weight percent of a plant based gum;
adding 0.005-0.06 weight percent of a capsicum extract;
adding 0.001-0.05 weight percent of a bitterant; and
adding 0.001-0.003 weight percent of a menthol.

10. The method of claim 9 further comprising the steps of:
adding 0.1-0.2% weight percent of citric acid,
adding 0.005-0.1% weight percent of stevia,
adding 0.005-0.002% weight percent of vanillin,
adding 0.1-0.2% weight percent of emulsifier,
adding 0.03-0.06% of weight percent preservative; and
adding 1-2% weight percent of flavorings to create a beverage that mimics the characteristics of gin.

11. The method of claim 9 further comprising the steps of:
adding 0.1-0.2% weight percent of citric acid;
adding 20-30% weight percent of erythritol;
adding 0.01-0.3% weight percent of monk fruit extract;
adding 0.002-0.005% weight percent of vanillin;
adding 0.1-0.2% weight percent of emulsifier;
adding 0.03-0.06% weight percent of preservative; and
adding 2-4% weight percent of flavorings to create a beverage that mimics the characteristics of an orange liqueur.

12. The method of claim 9 further comprising the steps of:
adding 0.1-0.2% weight percent of citric acid;
adding 20-30% weight percent of erythritol;
adding 0.01-0.3% weight percent of monk fruit extract;
adding 0.002-0.005% weight percent of vanillin;
adding 0.1-0.2% weight percent of emulsifier;
adding 0.03-0.06% weight percent of preservative;
adding 1-3% weight percent of flavorings;
adding 0.1-0.5% weight percent of coloring; and
adding 0.1-0.5% weight percent of digestive root extracts to create a beverage that mimics the characteristics of a bittersweet aperitif.
